(19) United States
(12) Patent Application Publication
(10) Pub. No.: US 2024/0169412 A1
(43) Pub. Date: May 23, 2024

(54) INFORMATION PROCESSING DEVICE, RECCOMENDED INFORMATION GENERATION METHOD, AND STORAGE MEDIUM

(71) Applicant: NEC Corporation, Minato-ku, Tokyo (JP)

(72) Inventor: Remina TAKAHASHI, Tokyo (JP)

(73) Assignee: NEC Corporation, Minato-ku, Tokyo (JP)

(21) Appl. No.: 18/280,850

(22) PCT Filed: Mar. 15, 2021
(86) PCT No.: PCT/JP2021/010312

§ 371 Date: Sep. 7, 2023

(51) Int. Cl. G06Q 30/0601

(52) U.S. Cl. CPC G06Q 30/0631

(57) ABSTRACT

In order to enhance convenience of the data distribution service, an information processing apparatus (1) includes: a related user extracting section (11) that extracts a related user relating to the target user on the basis of target user associated information which is associated with a target user; and a recommendation information generating section (12) that generates, on the basis of related user associated information which is associated with the related user, recommendation information indicating data obtaining of which is recommended to the target user.

### TECHNICAL FIELD

The present invention relates to an information processing apparatus and the like recommending data in a data distribution service.

### BACKGROUND ART

A data distribution service, which allows data registered by a certain user to be obtained by another user, is prevailing in recent years. A user of the data distribution service can register data in the data distribution service, and also can obtain, through the data distribution service, data registered by another user. Such a data distribution service is convenient. However, the data distribution service has various kinds of data registered therein, and therefore it is sometimes difficult for a user to find data useful for him/her by himself/herself. A prior art for solving this problem can be, for example, a data management apparatus disclosed in Patent Literature 1 indicated below. This data management apparatus extracts, on the basis of metadata of data provided by a subscriber of a service, data relating to the data, and then recommends the extracted data to the subscriber. With this configuration, the subscriber can easily find data useful for him/her.

### CITATION LIST

### Patent Literature

Patent Literature 1
Japanese Patent Application Publication, Tokukai, No. 2020-024645

### SUMMARY OF INVENTION

### Technical Problem

However, since the technique disclosed in Patent Literature 1 recommends the data relating to the data provided by the service subscriber himself/herself, the data to be recommended is limited to data within a range that can be expected by the subscriber. Thus, the technique disclosed in Patent Literature 1 has room for improvement in terms of enhancement of convenience of the data distribution service.

An example aspect of the present invention was made in view of the above problem. An example object of the present invention is to provide an information processing apparatus and the like that can enhance convenience of a data distribution service.

### Solution to Problem

An information processing apparatus in accordance with an example aspect of the present invention includes: a related user extracting means that extracts, for a target user among a plurality of users of a data distribution service, at least one related user relating to the target user from among the plurality of users on a basis of target user associated information which is associated with the target user, the data distribution service allowing data registered by a certain one of the plurality of users to be obtained by another one of the plurality of users; and a recommendation information generating means that generates, on a basis of related user associated information which is associated with the at least one related user, recommendation information indicating data which is included in data obtainable through the data distribution service and obtaining of which is recommended to the target user.

A recommendation information generation method in accordance with an example aspect of the present invention includes: at least one processor extracting, for a target user among a plurality of users of a data distribution service, at least one related user relating to the target user from among the plurality of users on a basis of target user associated information which is associated with the target user, the data distribution service allowing data registered by a certain one of the plurality of users to be obtained by another one of the plurality of users; and at least one processor generating, on a basis of related user associated information which is associated with the at least one related user, recommendation information indicating data which is included in data obtainable through the data distribution service and obtaining of which is recommended to the target user.

A recommendation information generation program in accordance with an example aspect of the present invention causes a computer to function as: a related user extracting means that extracts, for a target user among a plurality of users of a data distribution service, at least one related user relating to the target user from among the plurality of users on a basis of target user associated information which is associated with the target user, the data distribution service allowing data registered by a certain one of the plurality of users to be obtained by another one of the plurality of users; and a recommendation information generating means that generates, on a basis of related user associated information which is associated with the at least one related user, recommendation information indicating data which is included in data obtainable through the data distribution service and obtaining of which is recommended to the target user.

### Advantageous Effects of Invention

According to an example aspect of the present invention, it is possible to enhance convenience of a data distribution service.

### BRIEF DESCRIPTION OF DRAWINGS

FIG. 1 is a block diagram illustrating a configuration of an information processing apparatus in accordance with a first example embodiment of the present invention.

FIG. 2 is a flowchart illustrating a flow of a recommendation information generation method in accordance with the first example embodiment of the present invention.

FIG. 3 is a view illustrating an outline of a recommendation information generation system in accordance with a second example embodiment of the present invention.

FIG. 4 is a block diagram illustrating an example of a configuration of a main part of an information processing apparatus included in the recommendation information generation system.

FIG. 5 is a view illustrating an example of management information stored in the information processing apparatus.

FIG. 6 is a flowchart illustrating a flow of a recommendation information generation method executed by the information processing apparatus.

FIG. 7 is a view illustrating a specific example of the recommendation information generation method.

FIG. 8 is a view illustrating an example in which recommendation information is generated on the basis of a frequency in interest information and a frequency in FB information.

FIG. 9 is a view illustrating an example in which recommendation information is generated on the basis of frequencies in respective industry categories.

FIG. 10 is a view illustrating an example in which recommendation information is generated in accordance with user's designation.

FIG. 11 is a flowchart illustrating a flow of a recommendation information generation method involving use of orientation information.

FIG. 12 is a view illustrating an example of a computer executing instructions of a program which is software realizing functions of each of the information processing apparatuses in accordance with the example embodiments of the present invention.

### DESCRIPTION OF EMBODIMENTS

### First Example Embodiment

The following description will discuss a first example embodiment of the present invention in detail with reference to the drawings. The present example embodiment is a basic form of example embodiments described later.

(Configuration of Information Processing Apparatus)

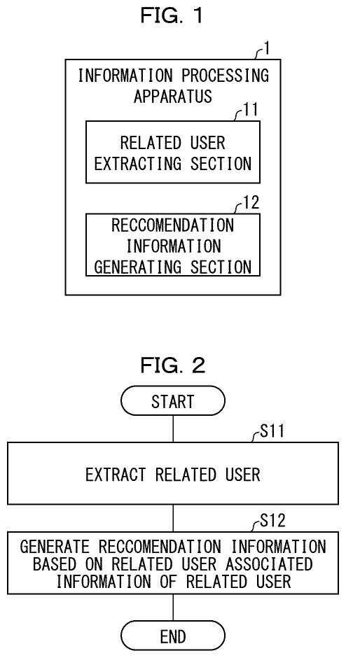

The following will describe, with reference to FIG. 1, a configuration of an information processing apparatus 1 in accordance with the present example embodiment. FIG. 1 is a block diagram illustrating a configuration of the information processing apparatus 1. As shown in FIG. 1, the information processing apparatus 1 includes a related user extracting section 11 and a recommendation information generating section 12.

The related user extracting section 11 extracts, for a target user among a plurality of users of a data distribution service, a related user relating to the target user from among the plurality of users, on the basis of target user associated information which is associated with the target user, the data distribution service allowing data registered by a certain one of the plurality of users (hereinafter, such data will be referred to as “registered data”) to be obtained by another one of the plurality of users.

The recommendation information generating section 12 generates, on the basis of related user associated information which is associated with the related user, recommendation information indicating a piece of registered data (hereinafter, referred to as “recommended registered data”) which is included in pieces of registered data obtainable through the data distribution service and obtaining of which is recommended to the target user.

As described above, the information processing apparatus 1 in accordance with the present example embodiment includes: the related user extracting section 11 that extracts, for a target user among a plurality of users of a data distribution service, a related user relating to the target user from among the plurality of users, on the basis of target user associated information which is associated with the target user; and a recommendation information generating section 12 that generates, on the basis of related user associated information which is associated with the related user, recommendation information indicating recommended registered data. Therefore, with the information processing apparatus 1 in accordance with the present example embodiment, it is possible to recommend, to the target user, registered data whose usefulness is difficult to be found by the target user. This can provide an effect of enhancing convenience of the data distribution service.

(Recommendation information Generation Program)

The function of the above-described information processing apparatus 1 can be realized by a program. A recommendation information generation program in accordance with the present example embodiment is configured to cause a computer to function as: a related user extracting means that extracts, for a target user among a plurality of users of a data distribution service, a related user relating to the target user from among the plurality of users, on the basis of target user associated information which is associated with the target user; and a recommendation information generating means that generates, on the basis of related user associated information which is associated with the related user, recommendation information indicating recommended registered data which is included in pieces of registered data obtainable through the data distribution service and obtaining of which is recommended to the target user. Therefore, with the recommendation information generation program in accordance with the present example embodiment, it is possible to recommend, to the target user, registered data whose usefulness is difficult to be found by the target user. This can provide an effect of enhancing convenience of the data distribution service.

(Flow of Recommendation information Generation Method)

The following will describe, with reference to FIG. 2, a flow of a recommendation information generation method in accordance with the present example embodiment. FIG. 2 is a flowchart illustrating a flow of the recommendation information generation method. Note that steps of the recommendation information generation method may be carried out by a processor of the information processing apparatus 1 or by a processor of another apparatus. Alternatively, the steps may be carried out by processors provided in respective different apparatuses.

In S11, at least one processor extracts, for a target user among a plurality of users of a data distribution service, a related user relating to the target user from among the plurality of users, on the basis of target user associated information which is associated with the target user.

In S12, the at least one processor generates, on the basis of related user associated information which is associated with the related user extracted in S11, recommendation information indicating recommended registered data which is included in pieces of registered data obtainable through the data distribution service and obtaining of which is recommended to the target user.

As described above, the recommendation information generation method in accordance with the present example embodiment is configured to: extract, for a target user among a plurality of users of a data distribution service, a related user relating to the target user from among the plurality of users, on the basis of target user associated information which is associated with the target user; and generate, on the basis of related user associated information which is associated with the related user, recommendation information indicating recommended registered data which is included in pieces of registered data obtainable through the data distribution service and obtaining of which is recommended to the target user. Therefore, with the recommendation information generation method in accordance with the present example embodiment, it is possible to recommend, to the target user, registered data whose usefulness is difficult to be found by the target user. This can provide an effect of enhancing convenience of the data distribution service.

### Second Example Embodiment

(Outline of Recommendation information Generation System 100)

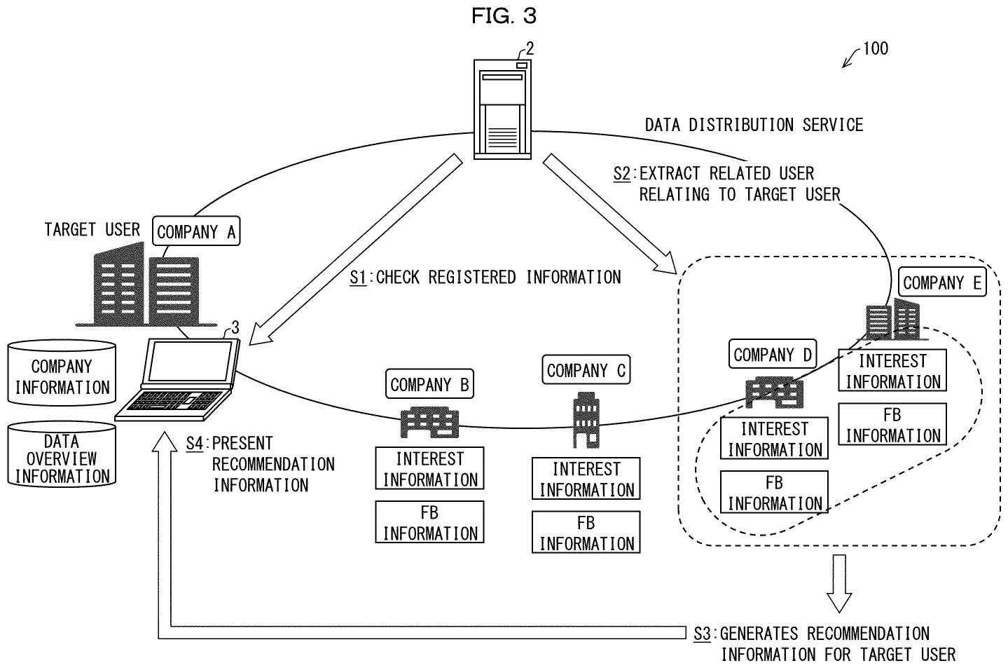

The following description will discuss a second example embodiment of the present invention in detail with reference to FIGS. 3 to 11. First, with reference to FIG. 3, the following will describe an outline of a recommendation information generation system 100 in accordance with the present example embodiment. FIG. 3 is a view illustrating an outline of the recommendation information generation system 100.

As shown in FIG. 3, the recommendation information generation system 100 includes an information processing apparatus 2 and a terminal apparatus 3. The information processing apparatus 2 is an apparatus that provides a platform of a data distribution service, whereas the terminal apparatus 3 is an apparatus that is to be used by a target user who uses the data distribution service.

The data distribution service is a service allowing registered data registered by a certain user to be obtained by another user. The following description will discuss an example in which the data distribution service is a service that employs a registration system, that is available only for a registered user, and that requires, as a requirement for registration, the user to register data which may be provided to other users. In the example described here, the user of the data distribution service is a company. Of course, the data distribution service may alternatively be a service that is available also for a non-registered user and a user who does not provide data. Further, the user of the data distribution service is not limited to the company.

The registered data may be any data that has a high value of use for a user of the data distribution service. Preferably, the registered data is data collected by the user by himself/herself. For example, in a case where the user is a store owner, the registered data may be a data table indicating history of sales, history of the number of customers, and/or the like of his/her store.

The information processing apparatus 2 accepts user registration in the data distribution service. Further, as described above, since the registered user needs to register data, the information processing apparatus 2 accepts uploading of the registered data. Furthermore, the information processing apparatus 2 also carries out a process of accepting an obtaining request to registered data and causing a user who has requested the registered data to download the registered data.

For example, in the example shown in FIG. 3, a total of five companies, Companies A to E, are registered in the data distribution service. All of these companies provide registered data to the data distribution service. Each company can obtain registered data provided by other companies.

Further, each of these companies also registers, in the information processing apparatus 2, (i) company information indicating a company name, an industry category, and/or the like of the company, (ii) data overview information indicating an overview of registered data provided by the company, and (iii) interest information indicating registered data in which the company has interest in the data distribution service (hereinafter, such registered data will be referred to as “interest target data”).

Moreover, a company that has obtained registered data through the data distribution service sends a feedback to the obtained registered data. Thus, the obtained data and a content of the feedback given thereto are registered, as FB information, in the information processing apparatus 2.

Furthermore, the information processing apparatus 2 also carries out a process of presenting, to a user of the data distribution service, recommended registered data, which is registered data that is to be recommended. Specifically, the information processing apparatus 2 generates recommendation information indicating the recommended registered data, and causes the terminal apparatus 3 to display the recommendation information. In this manner, the information processing apparatus 2 presents the recommended registered data to a target user. For example, the information processing apparatus 2 may display the recommendation information on my page, which is an interface via which the user uses the data distribution service or may notify the recommendation information by, e.g., an e-mail.

In the example shown in FIG. 3, among the companies registered in the data distribution service, Company A is selected as the target user, and recommendation information is generated and is presented. In this case, the information processing apparatus 2 first checks the information registered in relation to Company A, specifically, company information and data overview information of Company A (51).

Then, the information processing apparatus 2 extracts, on the basis of the information checked in 51, a related user(s) relating to Company A from among the users registered in the data distribution service (S2). In the example shown in FIG. 3, Companies D and E are extracted.

In S2, on the basis of (i) various information relating to the target user (e.g., information indicating the industry category of the target user and/or the type of registered data registered by the target user) and (ii) various information relating to other user(s) (e.g., information indicating the industry category(ies) of the other user(s) and/or the type(s) of the registered data registered by the other user(s)), a company whose industry category and/or registered data is/are similar to those of the target user may be extracted as the related user(s) (details thereof will be described later).

Then, the information processing apparatus 2 generates recommendation information for Company A, which is the target user, on the basis of related user associated information which is associated with the related user(s) extracted in S2, specifically, on the basis of pieces of interest information and pieces of FB information of Companies D and E (S3).

In S3, the information processing apparatus 2 may analyze utilization record of the registered data and/or a utilization trend of the registered data of the related user(s) in the data distribution service, and may generate recommendation information on the basis of a result of the analysis. Note that the method for generating the recommendation information will be described in detail later.

Then, the information processing apparatus 2 presents, to Company A, the recommendation information generated in S3 (S4). There is no particular limitation on the method for presenting the recommendation information. For example, as described above, the recommendation information may be displayed on my page which is and is viewed by Company A through the terminal apparatus 3.

(Configuration of Information Processing Apparatus 2)

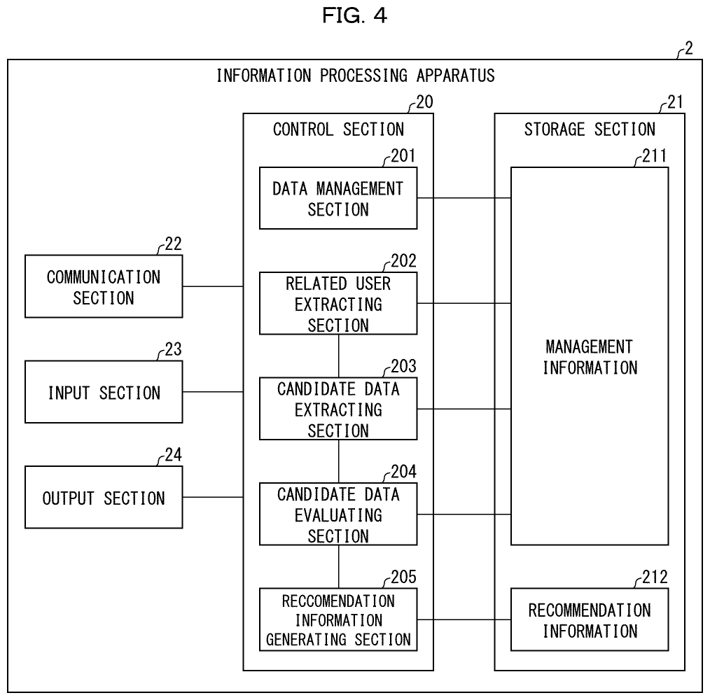

The following will describe, with reference to FIG. 4, a configuration of the information processing apparatus 2. FIG. 4 is a block diagram illustrating an example of a configuration of a main part of the information processing apparatus 2. As shown in FIG. 4, the information processing apparatus 2 includes a control section 20 that comprehensively controls sections of the information processing apparatus 2 and a storage section 21 in which various data used by the information processing apparatus 2 is stored. The information processing apparatus 2 further includes a communication section 22 via which the information processing apparatus 2 communicates with another apparatus, an input section 23 that receives input of various data given to the information processing apparatus 2, and an output section 24 via which the information processing apparatus 2 outputs various data.

Further, the control section 20 includes a data management section 201, a related user extracting section 202, a candidate data extracting section 203, a candidate data evaluating section 204, and a recommendation information generating section 205. Then, the storage section 21 has management information 211 and recommendation information 212 stored therein.

The data management section 201 carries out various processes necessary to provide the data distribution service. Specifically, the data management section 201 manages users of the data distribution service, registered data registered therein, and various information relating to them. For example, the data management section 201 accepts user registration to the data distribution service, accepts uploading of registered data, accepts an obtaining request for registered data, controls downloading, and the like.

The related user extracting section 202 extracts, for the target user of the data distribution service, a related user(s) relating to the target user from among the users of the data distribution service, on the basis of target user associated information which is associated with the target user. Details of the target user associated information and details of the method for extracting the related user(s) will be described later.

The candidate data extracting section 203 extracts, from among the pieces of registered data registered in the data distribution service, candidate data that is a candidate for recommended registered data obtaining of which is recommended to the target user. The extraction of the candidate data is carried out on the basis of related user associated information of the related user(s) extracted by the related user extracting section 202 (details thereof will be described later).

The candidate data evaluating section 204 evaluates the pieces of candidate data extracted by the candidate data extracting section 203. The evaluation may be carried out such that candidate data highly likely to be useful for the target user is given a higher evaluation. For example, it can be said that candidate data commonly included in related user associated information of many related users is highly likely to be useful for the target user. Thus, the candidate data evaluating section 204 may calculate, as an evaluation value, a frequency represented by the following equation, for example.

(Frequency)=100×(the number of pieces of candidate data included in related user associated information)/(the number of extracted related users)

The recommendation information generating section 205 generates, on the basis of the related user associated information which is associated with the related user(s), recommendation information indicating recommended registered data which is included in pieces of registered data obtainable through the data distribution service and obtaining of which is recommended to the target user. Specifically, on the basis of evaluation results on pieces of candidate data extracted on the basis of the related user associated information, the recommendation information generating section 205 determines, from among the pieces of candidate data, a piece of candidate data which is recommended to the target user, and generates recommendation information which recommends the piece of candidate data as recommended registered data.

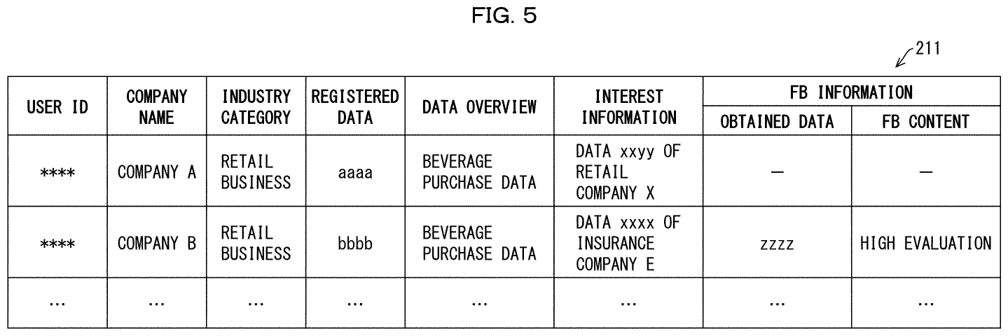

The management information 211 is information that manages the users of the data distribution service, the pieces of registered data thereof, and various information relating to them. The management information 211 may include the above-described target user associated information and related user associated information. Details of the management information 211 will be described later with reference to FIG. 5.

The recommendation information 212 is information indicating recommended registered data obtaining of which is recommended to a user of the data distribution service. In the above-described manner, pieces of recommendation information 212 for respective users are generated by the recommendation information generating section 205.

(Details of Management Information 211)

The following will describe, with reference to FIG. 5, details of the management information 211. FIG. 5 is a view illustrating an example of the management information 211. The management information 211 shown in FIG. 5 has a data structure in which a user ID, a company name, an industry category, registered data, a data overview, interest information, and FB information which are associated with each other.

The user ID is identification information used to uniquely identify a user of the data distribution service. The company name is information indicating a name of a company to which the user belongs. The industry category is information indicating an industry category of the company to which the user belongs. The company name and industry category are an example of the company information shown in FIG. 3. The company information only needs to relate to the company to which the user belongs. For example, the company information may include information indicating the location of a head office of the company and/or the size of the company (e.g., the number of employees and/or sales of the company). In the example shown in FIG. 5, the items of the “company name” of a first user and a second user are respectively “Company A” and “Company B”, and the items of the “industry category” of these users are each “retail business”.

The registered data is information indicating registered data of a user of the data distribution service. The management information 211 may store a registered data name, a storage destination of the registered data, or identification information (ID) of the registered data. Note that a single user may register a plurality of pieces of registered data. In the example shown in FIG. 5, the items of “registered data” of “Company A” and “Company B” are respectively “aaaa” and “bbbb”, which are registered data names.

The data overview is information indicating an overview of the registered data, and is similar to the “data overview information” shown in FIG. 3. In a case where a plurality of pieces of registered data are registered, data overviews are stored for the respective plurality of pieces of registered data. The data overview may indicate, for example, the type of the registered data. The data overview may be, for example, metadata of the registered data. In the example shown in FIG. 5, the items of “data overview” of the “Company A” and “Company B” are each “beverage purchase data”. This shows that the registered data of “Company A” and “Company B” is data relating to purchase of beverages.

The interest information is information relating to registered data in which the related user has interest. Alternatively, the interest information may be information indicating a certain industry category or an industry category in which the related user has interest. In the example shown in FIG. 5, the item of “interest information” of “Company A” is “data xxyy of Retail Company X”, and the item of “interest information” of “Company B” is “data xxxx of Insurance Company E”.

The registered data indicated as the interest information is interest target data, which is one of the pieces of registered data registered in the data distribution service and in which the related user has strong interest. The interest information may include at least information (e.g., a data name, ID, a storage destination of the interest target data) used to specify the interest target data.

The FB information is information indicating a content of a feedback given, by a user, to the obtained registered data. The FB information is stored for each of the pieces of obtained registered data. The FB information may be, for example, information indicating the related user's evaluation (e.g., classification into high evaluation or low evaluation, an evaluation value which is a numerical value indicating the evaluation) on the registered data. Alternatively, the FB information may be, for example, information indicating a quality of the registered data (e.g., the presence or absence of garbage data, accuracy of data, granularity) or information indicating an affinity with the registered data of the target user (e.g., a similarity to the registered data of the target user). In a case where there is no obtained registered data, such as in the case of Company A shown in FIG. 5, the FB information is also not registered. Meanwhile, in the example shown in FIG. 5, the information is stored which indicates that Company B has obtained the registered data named “zzzz” and has given a feedback rating “high evaluation” thereto.

(Flow of Recommendation information Generation Method)

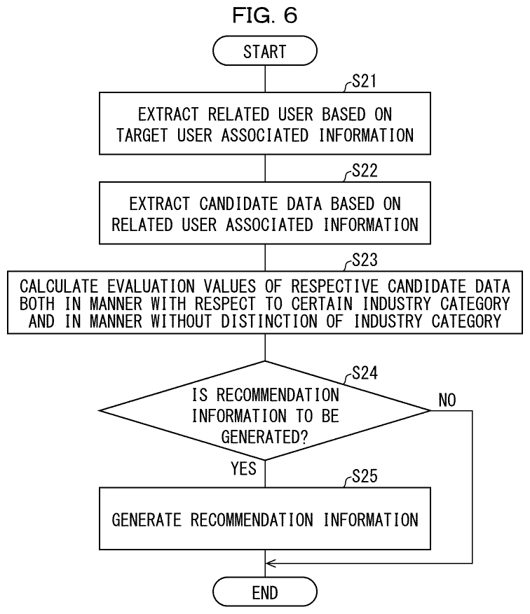

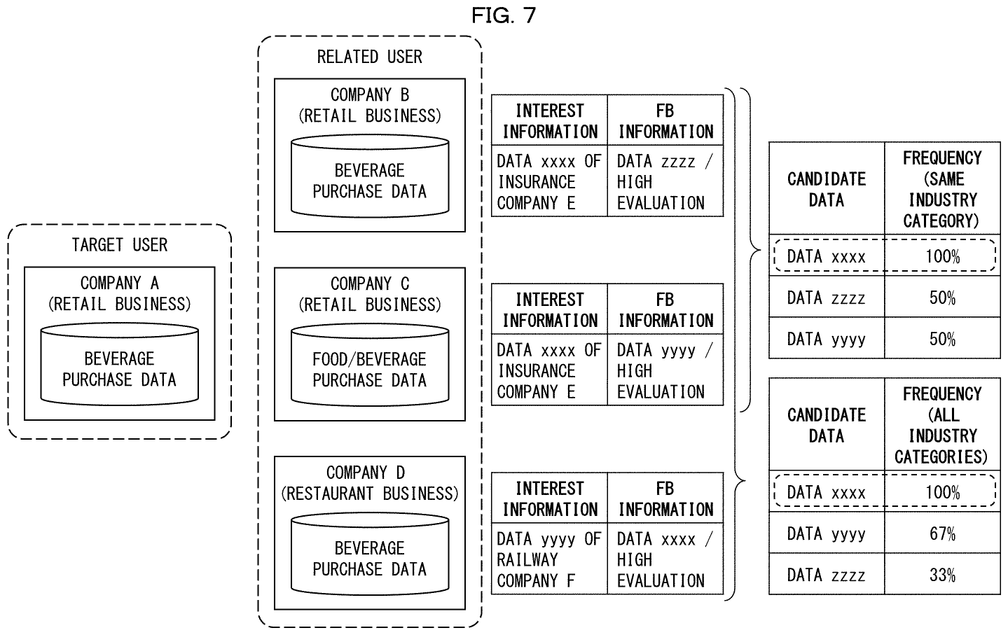

The following will describe, with reference to FIG. 6, a flow of a recommendation information generation method in accordance with the present example embodiment. FIG. 6 is a flowchart illustrating a flow of the recommendation information generation method executed by the information processing apparatus 2. Note that the following will also describe FIG. 7 illustrating a specific example of the recommendation information generation method.

In S21, the related user extracting section 202 extracts, for a target user to which recommendation information is to be presented, a related user(s) on the basis of target user associated information which is associated with the target user. Specifically, the related user extracting section 202 refers to “data overview” of management information 211, which is an example of target user associated information, so as to specify a user for which the same overview information as that for the target user is stored. Then, the related user extracting section 202 extracts, as a related user, the user thus specified.

For example, in the example shown in FIG. 7, the target user is Company A, and the registered data of Company A is “beverage purchase data”. The information indicating that the registered data of Company A is “beverage purchase data” is stored in “data overview” of the management information 211 (see FIG. 5). The related user extracting section 202 refers to “data overview” in the management information 211, so as to extract, as related users, Companies B and D, each of which has “beverage purchase data” as their registered data similarly to Company A.

Further, the related user extracting section 202 also extracts, as a related user, Company C, which has “food/beverage purchase data” as its registered data. The “food/beverage purchase data” is a broader category including “beverage purchase data”. In this manner, in S21 in FIG. 6, the related user extracting section 202 may extract a user who has registered data in the same category as the registered data of the target user, or may extract a user who has registered data of a category corresponding to the registered data of the target user. Note that categories to be dealt with as “corresponding categories” may be determined in advance. For example, categories including the same character string, such as “beverage purchase data” and “food/beverage purchase data”, may be set as corresponding categories.

In S22, the candidate data extracting section 203 extracts candidate data on the basis of pieces of related user associated information of the related users extracted in S21. Specifically, the candidate data extracting section 203 extracts, as the candidate data, “obtained data” indicated in “FB information” of the related user registered in the management information 211. Further, the candidate data extracting section 203 extracts, as the candidate data, interest target data indicated by “interest information” of the related user registered in the management information 211.

For example, in the example shown in FIG. 7, the interest information of Company B, which is one of the extracted related users, is “data xxxx of Insurance Company E”. Thus, the candidate data extracting section 203 extracts “data xxxx” as candidate data. Similarly, the candidate data extracting section 203 extracts, as candidate data, “xxxx data” from the interest information of Company C, and extracts, as candidate data, “data yyyy” from the interest information of Company D.

Further, the candidate data extracting section 203 extracts, as pieces of candidate data, “data zzzz”, “data yyyy”, and “data xxxx” registered as “obtained data” of “FB information” of Companies B to D. Note that, when certain candidate data (e.g., “data xxxx”) is extracted two or more times, the extracted pieces of data are merged. As a result of the above process, in the example shown in FIG. 7, three pieces of data, “data xxxx”, “data yyyy”, and “data zzzz”, are extracted as the pieces of candidate data.

Note that, in S22, it is not essential to extract the candidate data both from the interest information and the FB information. Alternatively, for example, the candidate data may be extracted from the interest information and no candidate data may be extracted from the FB information. Further alternatively, the candidate data may be extracted from the FB information and no candidate data may be extracted from the interest information.

In S23, the candidate data evaluating section 204 calculates evaluation values of the respective pieces of candidate data extracted in S22 both in a manner with respect to a certain industry category in a manner without distinction of the industry category. Specifically, the candidate data evaluating section 204 calculates an evaluation value with respect to all the pieces of candidate data extracted in S22, and calculates an evaluation value with respect to, among the pieces of candidate data extracted in S22, a piece(s) of candidate data extracted from interest information or FB information of a related user(s) of the same industry category as the target user.

For example, in the example shown in FIG. 7, calculated as the evaluation value is a frequency at which the candidate data is included in the related user associated information, i.e., the interest information and the FB information, of the related user(s) extracted in S21. Note that a frequency with respect to all the pieces of candidate data is calculated by the above-indicated equation.

Specifically, “data xxxx”, which is one of the pieces of candidate data, is included in the “interest information” of Companies B and C and in the “FB information” of Company D. Thus, the frequency is calculated as 100%. Further, the frequencies of “data yyyy of Railway Company F” and “data zzzz”, which are the remaining of the pieces of candidate data, are respectively 67% and 33%.

Meanwhile, the frequency with respect to a certain industry category can be calculated by the following equation.

(Frequency with respect to certain industry category)=(the number of pieces of candidate data included in related user associated information of related user of certain industry category)/(the number of extracted related users of certain industry category)

In the example shown in FIG. 7, the frequency is calculated for the related users of the same industry category as the target user of the retail business, i.e., for Companies B and C of the retail business. Specifically, “data xxxx”, which is one of the pieces of candidate data, is included in the “interest information” of Companies B and C, and therefore the frequency of “data xxxx” is 100%. Further, each of the frequencies of “data yyyy” and “data zzzz”, which are the remaining of the pieces of candidate data, is 50%.

In S24, the recommendation information generating section 205 determines, on the basis of a result of the calculation in S23, whether to generate recommendation information. For example, if an evaluation value not less than a given threshold is calculated in S23, the recommendation information generating section 205 may determine to generate the recommendation information. Meanwhile, if the evaluation value not less than the given threshold is not calculated in S23, the recommendation information generating section 205 may determine not to generate the recommendation information. If the determination result is YES in S24, the process advances to S25. If the determination result is NO in S24, the recommendation information generation method is ended.

For example, in the example shown in FIG. 7, assume that determination of whether to generate the recommendation information is made on the basis of the threshold which is 60%. Then, for the same industry category, there exists “data xxxx” whose frequency is 100%, and therefore a determination result in S24 is YES. Similarly, for all the industry categories, the frequency of “data xxxx” is also 100%, and therefore a determination result in S24 is YES. Note that, if it is determined to generate the recommendation information for at least either of the same industry category and all the industry categories, the determination result in S24 is YES.

In S25, the recommendation information generating section 205 generates the recommendation information on the basis of the result of the calculation in S23. As described above, since the evaluation value (in the example shown in FIG. 7, the frequency) is calculated on the basis of the related user associated information (the interest information and the FB information) which is associated with the related user(s), it can be said that, in S25, the recommendation information is generated on the basis of the related user associated information which is associated with the related user(s). Then, the recommendation information generating section 205 stores the generated recommendation information in the storage section 21 as recommendation information 212. Then, the recommendation information generation method is ended.

For example, in the example shown in FIG. 7, both for the same industry category and all the industry categories, recommendation information recommending obtaining of “data xxxx” of Insurance Company E is generated and stored. Note that, in a case where there are a plurality of pieces of candidate data each having a frequency not less than the threshold, pieces of recommendation information may be generated for the respective plurality of pieces of candidate data.

The recommendation information may include, in addition to the registered data name, a user who has registered the registered data. For example, in the example shown in FIG. 7, the recommendation information generating section 205 may generate recommendation information indicating “data xxxx of Insurance Company E”.

(Extraction of Related User)

As described above, the target user associated information may include information indicating a category of registered data that the target user has registered in the data distribution service. In this case, the information processing apparatus 2 in accordance with the present example embodiment may be configured such that the related user extracting section 202 extracts, as a related user, a user who has registered, in the data distribution service, data of a category identical to or corresponding to a category of the data that the target user has registered in the data distribution service.

It can be said that the user who has registered the data of the category identical to or corresponding to the category of the data that the target user has registered has similar characteristics to the target user. Therefore, it is highly likely that the registered data useful for such a user is also useful for the target user. Therefore, with the information processing apparatus 2 in accordance with the present example embodiment, it is possible to attain, in addition to the effect given by the information processing apparatus 1 in accordance with the first example embodiment, an effect of increasing the possibility of generating recommendation information indicating registered data useful for the target user.

The target user associated information may include information indicating an industry category of the target user. In this case, the information processing apparatus 2 in accordance with the present example embodiment may be configured such that, in S21 of FIG. 6, the related user extracting section 202 extracts, as a related user, a user of an industry category identical to or corresponding to that of the target user. Note that industry categories to be dealt with as “corresponding industry categories” may be determined in advance.

It can be said that the user of the industry category identical to or corresponding to the industry category of the target user has similar characteristics to the target user. Therefore, it is highly likely that the registered data useful for such a user is also useful for the target user. Therefore, with the information processing apparatus 2 in accordance with the present example embodiment, it is possible to attain, in addition to the effect given by the information processing apparatus 1 in accordance with the first example embodiment, an effect of increasing the possibility of generating recommendation information indicating registered data useful for the target user.

(Extraction of Related User Using AI)

The related user extracting section 202 may extract the related user with use of Artificial Intelligence (AI). For example, the related user extracting section 202 may classify, with use of AI that classifies pieces of registered data into categories, a piece of registered data of the target user and pieces of registered data of other users into categories. In this case, the related user extracting section 202 may extract, as a related user, a user who has registered a piece of registered data classified into the same category as that of the target user.

Such AI can be constructed by machine learning involving use of pieces of registered data classified into known categories. Such AI can also be referred to as a classification model for category classification. Further, the learning of the AI may be carried out with use of various information relating to the categories of the pieces of registered data, e.g., metadata of the pieces of registered data. In this case, the various information may be used together with or instead of the pieces of registered data.

Here, assume that the pieces of registered data are pieces of data indicating numerical values of respective sequences, such as a data table, but do not indicate sequence names. Generally, it is difficult to classify such pieces of registered data into categories properly. Thus, in such a case, in accordance with the tendency of a distribution of numerical values of a certain sequence indicated by the pieces of registered data, the related user extracting section 202 may estimate names of the sequence with use of AI and then carry out category classification. The AI used in such a case can be constructed by machine learning involving use of a group of numerical values whose sequence names are known. Further, in a case where the pieces of registered data include pieces of registered data of a plurality of sequences and some of these pieces of registered data are not indicated with their sequence names, sequence names not indicated for some pieces of registered data may be estimated also in consideration of sequence names indicated for the other pieces of registered data.

Further, the related user extracting section 202 may extract a related user by analyzing a word included in the piece of registered data of each user. For example, the related user extracting section 202 may extract, as a related user, a user who has registered a piece of registered data including (i) the same word as that in the piece of registered data registered by the target user or (ii) a word having the same meaning as that of a word in the piece of registered data registered by the target user (or metadata of the piece of registered data). For another example, the related user extracting section 202 may calculate a similarity between pieces of registered data on the basis of the number of same words or words having the same meanings, and may extract, as a related user, a user who has registered a piece of registered data having a high similarity.

(Generation of Recommendation Information)

As described above, the related user associated information may include interest information indicating interest target data, which is data in which the related user has interest. Further, in this case, the information processing apparatus 2 in accordance with the present example embodiment may be configured such that the recommendation information generating section 205 generates recommendation information recommending obtaining of interest target data indicated by the interest information.

The interest target data is data in which the related user relating to the target user has interest. Therefore, it is highly likely that the interest target data is useful for the target user. Therefore, with the information processing apparatus 2 in accordance with the present example embodiment, it is possible to attain, in addition to the effect given by the information processing apparatus 1 in accordance with the first example embodiment, an effect of increasing the possibility of generating recommendation information indicating registered data useful for the target user.

Further, as described above, the related user associated information may include information indicating obtained data, which is data that the related user has obtained through the data distribution service. Further, in this case, the information processing apparatus 2 in accordance with the present example embodiment may be configured such that the recommendation information generating section 205 generates recommendation information recommending obtaining of the obtained data.

It is highly likely that the obtained data that the related user relating to the target user has actually obtained is useful for the target user. Therefore, with the information processing apparatus 2 in accordance with the present example embodiment, it is possible to attain, in addition to the effect given by the information processing apparatus 1 in accordance with the first example embodiment, an effect of increasing the possibility of generating recommendation information indicating registered data useful for the target user.

(Generation of Recommendation information in Consideration of FB Information)

As described above, the related user associated information may include FB information indicating a content of a feedback given, by the related user, to the obtained data. In this case, the information processing apparatus 2 in accordance with the present example embodiment may be configured such that the recommendation information generating section 205 generates recommendation information recommending obtaining of the obtained data to which a feedback having a certain content has been given.

As described above, it is highly likely that the obtained data that the related user has actually obtained is useful for the target user. Further, the content of the feedback given to the obtained data is a useful material to determine whether or not the obtained data is useful for the target user. Therefore, with the information processing apparatus 2 in accordance with the present example embodiment, it is possible to attain, in addition to the effect given by the information processing apparatus 1 in accordance with the first example embodiment, an effect of further increasing the possibility of generating recommendation information indicating registered data useful for the target user.

For example, the recommendation information generating section 205 may generate recommendation information recommending obtaining of obtained data to which a positive feedback has been given. Conversely, the recommendation information generating section 205 may generate recommendation information recommending obtaining of obtained data to which a negative feedback has been given. The reason is that some target users may have interest in registered data to which a negative feedback has been given by another user.

Further, for example, the recommendation information generating section 205 may calculate a ratio between positive feedbacks and negative feedbacks and incorporate the ratio thus calculated into the recommendation information. For example, assume that data X for which FB information indicates a highest frequency has received 80% positive feedbacks and 20% negative feedbacks. In such a case, the recommendation information generating section 205 may select the data X as the recommended registered data and incorporate, into the recommendation information, information indicating a ratio between the positive feedbacks and the negative feedbacks.

### Example 1 of Generation of Recommendation Information

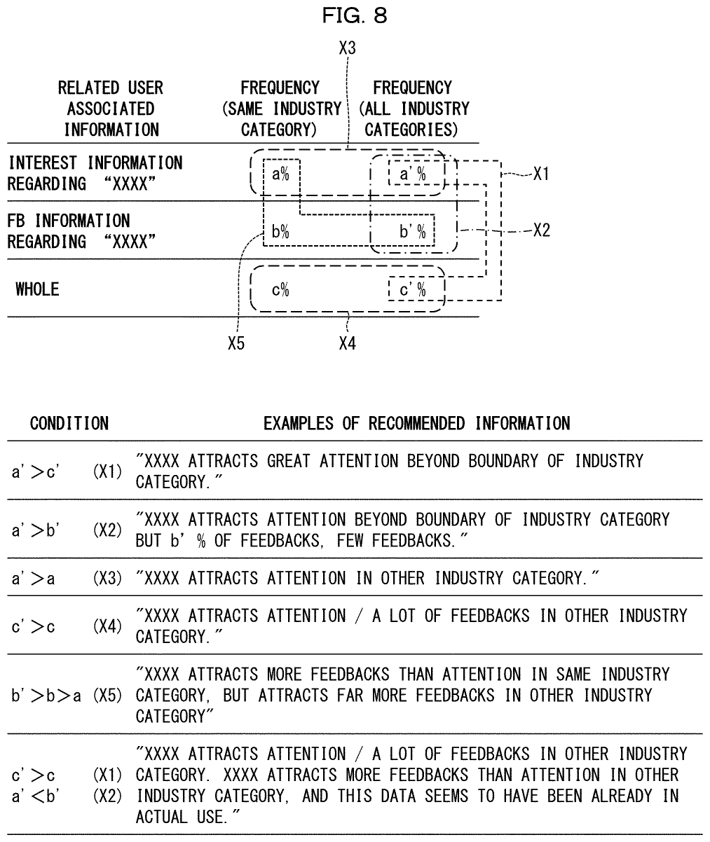

The recommendation information may indicate not only the recommended registered data obtaining of which is recommended but also various analysis results relating to the recommended registered data. This will be described with reference to FIG. 8. FIG. 8 is a view illustrating an example in which recommendation information is generated on the basis of a frequency in interest information and a frequency in FB information.

The example shown in FIG. 8 assumes a case where the candidate data evaluating section 204 calculates a frequency in the whole of the related user associated information including the interest information and the FB information as in the example shown in FIG. 7 and the candidate data evaluating section 204 also calculates a frequency in the interest information and a frequency in the FB information. For example, in the example shown in FIG. 7, in a case where a frequency in the interest information is calculated with respect to all the industry categories, the calculation can be carried out according to the following equation.

(Frequency in interest information)=(the number of pieces of candidate data included in interest information)/(the number of extracted related users)

For example, in the example shown in FIG. 7, in a case where a frequency in the interest information is calculated with respect to all the industry categories, a frequency of “data xxxx” is 67% and a frequency of “data yyyy” is 33%.

In a case where a frequency in the interest information is calculated with respect to a certain industry category, the calculation can be carried out according to the following equation.

(Frequency in interest information of certain industry category)=(the number of pieces of candidate data included in interest information of related users of certain industry category)/(the number of extracted related users of certain industry category)

Thus, in the example shown in FIG. 7, in a case where a frequency in the interest information is calculated with respect to a related user(s) of the same industry category as the target user, a frequency of “data xxxx” is 100%.

This also applies to the FB information. In the example shown in FIG. 7, in a case where a frequency in the FB information is calculated with respect to all the industry categories, frequencies of “data xxxx”, “data yyyy”, and “data zzzz” are each 33%. In the example shown in FIG. 7, in a case where a frequency in the FB information is calculated with respect to a related user(s) of the same industry category as the target user, frequencies of “data yyyy” and “data zzzz” are each 50%.

The candidate data evaluating section 204 calculates, for the pieces of candidate data extracted by the candidate data extracting section 203, six types of frequencies in the above-discussed manner. The upper part of FIG. 8 shows a table indicating the six types of frequencies.

As shown in this table, the six types of frequencies include three types obtained for the same industry category and three types obtained for all the industry categories. The former includes a frequency (a %) in the interest information, a frequency (b %) in the FB information, and a frequency (c %) in the whole including the interest information and the FB information. The latter also includes a frequency (a′%) in the interest information, a frequency (b′%) in the FB information, and a frequency (c′%) in the whole including the interest information and the FB information.

The recommendation information generating section 205 generates the recommendation information on the basis of the values of the six types of frequencies calculated for each of the pieces of candidate data. For example, the recommendation information generating section 205 may generate recommendation information recommending a piece of candidate data whose frequency (c′%) in the whole including the interest information and the FB information calculated with respect to all the industry categories is not less than the threshold.

In this case, as indicated by a frame X1 in FIG. 8, the recommendation information generating section 205 may make comparison between (i) the frequency (a′%) in the interest information with respect to all the industry categories and (ii) the frequency (c′%) in the whole including the interest information and the FB information with respect to all the industry categories. Then, if a result of the comparison is a′>c′, the recommendation information generating section 205 may generate recommendation information indicating that data “XXXX” attracts great attention beyond the boundary of the industry category, as shown in FIG. 8. Meanwhile, if a result of the comparison is a′<c′, the recommendation information generating section 205 may generate recommendation information indicating that the data “XXXX” attracts a lot of feedbacks beyond the boundary of the industry category. Note that the data “XXXX” is one of the pieces of candidate data.

Further, similarly, if a result of the comparison is a>c, the recommendation information generating section 205 may generate recommendation information indicating that the data “XXXX” attracts great attention in the same industry category. Meanwhile, if a result of the comparison is a<c, the recommendation information generating section 205 may generate recommendation information indicating that the data “XXXX” collects a lot of feedbacks in the same industry category.

In comparison between a′ and c′, if a difference between a′ and c′ is not less than a threshold, the recommendation information generating section 205 may determine that a′>c′. For example, if a difference between a′ and c′ is not less than 10%, the recommendation information generating section 205 may determine that a′>c′. Similarly, if a ratio between a′ and c′ is not less than the threshold, the recommendation information generating section 205 may determine that a′>c′. For example, if a ratio between a′ and c′ is not less than 1.2, the recommendation information generating section 205 may determine that a′>c′. This is true also of the above-discussed comparison between a and c and other conditions discussed below.

Further, as indicated by a frame X2 in FIG. 8, the recommendation information generating section 205 may make comparison between (i) the frequency (a′%) in the interest information with respect to all the industry categories and (ii) the frequency (b′%) in the FB information with respect to all the industry categories. Then, if a result of the comparison is a′>b′, the recommendation information generating section 205 may generate recommendation information indicating that the data “XXXX” attracts attention beyond the boundary of the industry category but few feedbacks, as shown in FIG. 8.

Further, as indicated by a frame X3 in FIG. 8, the recommendation information generating section 205 may make comparison between (i) the frequency (a′%) in the interest information with respect to all the industry categories and (ii) the frequency (a %) in the interest information with respect to the same industry category. Then, if a result of the comparison is a′>a, the recommendation information generating section 205 may generate recommendation information indicating that the data “XXXX” attracts attention in other industry category(ies), as shown in FIG. 8.

Further, as indicated by a frame X4 in FIG. 8, the recommendation information generating section 205 may make comparison between (i) the frequency (c′%) in the whole including the interest information and the FB information with respect to all the industry categories and (ii) the frequency (c %) in the whole including the interest information and the FB information with respect to the same industry category. Then, if a result of the comparison is c′>c, the recommendation information generating section 205 may generate recommendation information indicating that the data “XXXX” attracts attention or a lot of feedbacks in other industry category(ies), as shown in FIG. 8.

Further, as indicated by a frame X5 in FIG. 8, the recommendation information generating section 205 may make comparison between (i) the frequency (b′%) in the FB information with respect to all the industry categories, (ii) the frequency (a %) in the interest information with respect to the same industry category, and (iii) the frequency (b %) in the FB information with respect to the same industry category. Then, if a result of the comparison is a′>b′, the recommendation information generating section 205 may generate recommendation information indicating that the data “XXXX” attracts attention beyond the boundary of the industry category but few feedbacks, as shown in FIG. 8.

Further, the recommendation information generating section 205 may make both of the comparison indicated by the frame X1 and the comparison indicated by the frame X2 in FIG. 8. Then, if a result of the comparison is c′>c and a′<b′, the recommendation information generating section 205 may generate recommendation information indicating that the data “XXXX” attracts attention or a lot of feedbacks in other industry category(ies) and that, in other industry category(ies), the data “XXXX” attracts more feedbacks than interest and this data seems to have been already in actual use, as shown in FIG. 8.

As described above, the recommendation information generating section 205 may generate recommendation information having a content corresponding to a correlation between the frequency in the same industry category and the frequency in all the industry categories. Further, as described above, the recommendation information generating section 205 may generate recommendation information having a content corresponding to a correlation between the frequency in the related information and the frequency in the FB information. This makes it possible to provide the target user with a material to determine whether to obtain the recommended piece of registered data.

### Example 2 of Generation of Recommendation Information

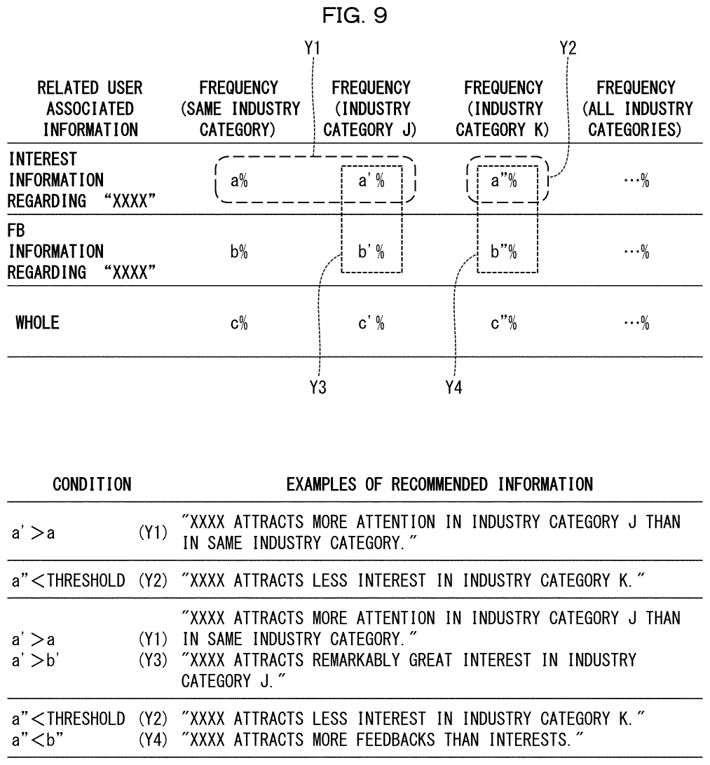

In the foregoing examples, regarding the frequency with respect to the certain industry category, the candidate data evaluating section 204 calculates the frequency in the same industry category and the frequency in other industry category(ies). Alternatively, the candidate data evaluating section 204 may calculate a frequency in an individual industry category. In this case, the recommendation information generating section 205 may generate recommendation information on the basis of frequencies in the respective industry categories. This will be described with reference to FIG. 9. FIG. 9 is a view illustrating an example in which recommendation information is generated on the basis of frequencies in respective industry categories.

In the example shown in FIG. 9, the candidate data evaluating section 204 calculates, with respect to all the industry categories, a frequency in the whole of the related user associated information including the interest information and the FB information, a frequency in the interest information, and a frequency in the FB information. The candidate data evaluating section 204 calculates, also with respect to each individual industry category, a frequency in the whole of the related user associated information, a frequency in the interest information, and a frequency in the FB information.

A table shown in the upper part of FIG. 9 indicates a frequency (a %) in the interest information, a frequency (b %) in the FB information, and a frequency (c %) in the whole including the interest information and the FB information, each of the frequencies being calculated with respect to the same industry category. This table also indicates a frequency (a′%) in the interest information, a frequency (b′%) in the FB information, and a frequency (c′%) in the whole including the interest information and the FB information, each of the frequencies being calculated with respect to an industry category J (which is different from the industry category of the target user). This table further indicates a frequency (a″%) in the interest information, a frequency (b″%) in the FB information, and a frequency (c″%) in the whole including the interest information and the FB information, each of the frequencies being calculated with respect to an industry category K (which is different from the industry category of the target user and the industry category J).

The recommendation information generating section 205 generates the recommendation information on the basis of the values of the frequencies calculated for the respective pieces of candidate data. For example, as indicated by a frame Y1 in FIG. 9, the recommendation information generating section 205 makes comparison between (i) a frequency (a %) in the interest information with respect to the same industry category and (ii) a frequency (a′%) in the interest information with respect to the industry category J. Then, if a result of the comparison is a′>a, the recommendation information generating section 205 may generate recommendation information indicating that the data “XXXX” attracts more attention in the industry category J than in the same industry category, as shown in FIG. 9.

The recommendation information generating section 205 may extract a piece of candidate data having a high frequency or a low frequency in some of the industry categories and generate recommendation information relating to the piece of candidate data. For example, the recommendation information generating section 205 may extract, from among the calculated frequencies, a frequency less than the threshold, and may generate recommendation information indicating that data corresponding to the extracted frequency attracts less interest or few feedbacks. For example, in the example shown in FIG. 9, in a case where the frequency (a″%), shown by a frame Y2, in the interest information of the data “XXXX” with respect to the industry category K is less than the threshold, the recommendation information generating section 205 may generate recommendation information indicating that the data “XXXX” attracts less interest in the industry category K.

Further, the recommendation information generating section 205 may generate recommendation information corresponding to a magnitude relation between the frequency in the interest information and the frequency in the FB information. For example, as indicated by frames Y1 and Y3 in FIG. 9, the recommendation information generating section 205 may make comparison between the frequency (a %) in the interest information with respect to the same industry category and the frequency (a′%) in the interest information with respect to the industry category J and then make comparison between the frequency (a′%) in the interest information with respect to the industry category J and the frequency (b′%) in the FB information with respect to the industry category J. Then, if a result of the comparison in the former is a′>a and a result of the comparison in the latter is a′>b′, the recommendation information generating section 205 may generate recommendation information indicating that the data “XXXX” attracts more attention in the industry category J than in the same industry category and that the data “XXXX” attracts remarkably great interest.

Further, for example, as indicated by frames Y2 and Y4 in FIG. 9, if the frequency (a″%) of the interest information with respect to the industry category K is not more than the threshold, the recommendation information generating section 205 may make comparison between the frequency (a″%) in the interest information and the frequency (b″%) in the FB information regarding the industry category K. Then, if a result of the comparison is a″<b″, the recommendation information generating section 205 may generate, for the data “XXXX”, recommendation information indicating that, in the industry category K, the data “XXXX” attracts less interest and attracts more feedbacks than interest.

### Example 3 of Generation of Recommendation Information

The information processing apparatus 2 may make the target user designate a condition for generation of recommendation information. The designation by the target user may be accepted via the communication section 22 or the input section 23. For example, in a case where designation is made to generate recommendation information with respect to a related user(s) of the same industry category, the recommendation information generating section 205 generates, in accordance with the designation, recommendation information on the basis of related user associated information of the related user(s) of the same industry category. For another example, in a case where a certain industry category is designated, the recommendation information generating section 205 generates recommendation information on the basis of related user associated information of a related user(s) of the designated industry category. Further, the threshold used to determine whether to generate the recommendation information may also be designated by the target user.

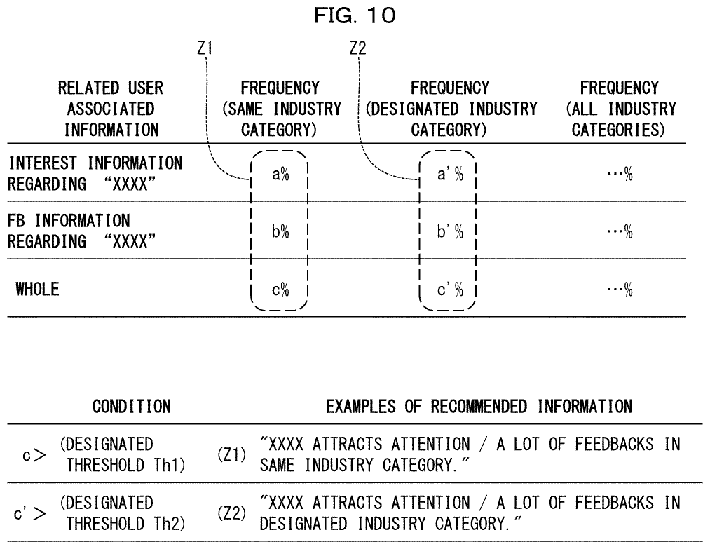

The following description will discuss, with reference to FIG. 10, generation of recommendation information carried out in accordance with the target user's designation. FIG. 10 is a view illustrating an example in which recommendation information is generated in accordance with user's designation. In a case where designation is made to generate recommendation information on the basis of related user associated information of a related user(s) of the same industry category, the recommendation information generating section 205 generates the recommendation information on the basis of a frequency in the same industry category, as indicted by a frame Z1 in FIG. 10.

In this case, assume that Th1 is designated as the threshold used to determine whether to generate the recommendation information. Then, if there is a piece of candidate data having a frequency exceeding the threshold Th1, the recommendation information generating section 205 generates recommendation information for the piece of candidate data. For example, in a case where the recommendation information generating section 205 determines whether to generate recommendation information on the basis of the frequency (c %) in the whole including the interest information and the FB information with respect to the same industry category, if the condition “c>Th1” is satisfied for the data “XXXX”, the recommendation information generating section 205 may generate recommendation information indicating that this data attracts attention or a lot of feedbacks in the same industry category.

Similarly, in a case where a certain industry category is designated, the recommendation information generating section 205 generates recommendation information on the basis of a frequency in the same certain industry category thus designated, as indicated by a frame Z2 in FIG. 10. In this case, assume that Th2 is designated as the threshold used to determine whether to generate the recommendation information. Then, if there is a piece of candidate data having a frequency exceeding the threshold Th2 for the certain industry category thus designated, the recommendation information generating section 205 generates recommendation information for the piece of candidate data. For example, in a case where the recommendation information generating section 205 determines whether to generate recommendation information on the basis of the frequency (c′%) in the whole including the interest information and the FB information, if the condition “e>Th2” is satisfied for the data “XXXX”, the recommendation information generating section 205 may generate recommendation information indicating that this data attracts attention or a lot of feedbacks in the designated industry category. Note that the thresholds Th1 and Th2 may be designated by the target user or may be set in advance.

As described above, the recommendation information generating section 205 may generate recommendation information on the basis of related user associated information of, from among a related user(s) extracted by the related user extracting section 202, a related user of a certain industry category. With this configuration, it is possible to attain, in addition to the effect given by the information processing apparatus 1 in accordance with the first example embodiment, an effect of enabling generation of recommendation information characteristic to the certain industry category. Note that the certain industry category may be the same as that of the target user or may be different from that of the target user. Alternatively, the certain industry category may be designated by the target user in the above-discussed manner.

### Example of Generation of Recommendation Information Using Orientation Information

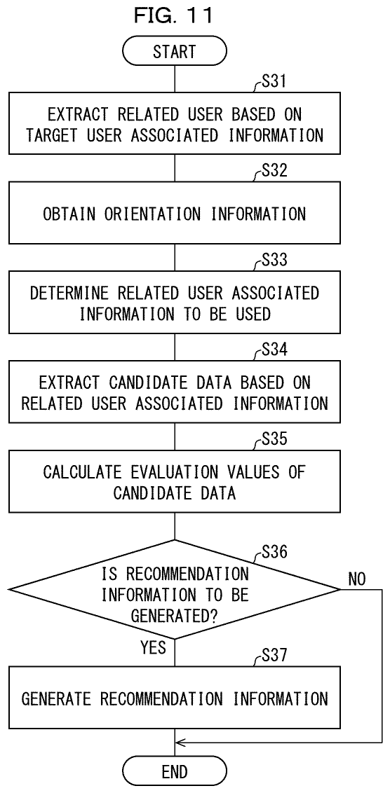

The information processing apparatus 2 can generate recommendation information corresponding to orientation information indicating the target user's intention. This will be described with reference to FIG. 11. FIG. 11 is a flowchart illustrating a flow of a recommendation information generation method involving use of orientation information. Note that S31 and S36 to S37 in FIG. 11 are respectively the same as S21 and S24 to S25 in FIG. 6. Therefore, the following description will be made focusing on the processes in S32 to S35.

In S32, the candidate data extracting section 203 obtains orientation information. The orientation information is information indicating orientation of the target user, i.e., what kind of data the target user prefers. For example, the orientation information may be information indicating that the target user prefers data attracting great interest of other companies or that the target user prefers data receiving high evaluation from other companies. For another example, the orientation information may be information indicating that the target user is future-oriented or innovation-oriented, that the target user is conservative-oriented, or that the target user is balanced, i.e., the target user is balanced between future-oriented or innovation-oriented and conservative-oriented.

There is no particular limitation on the method for obtaining the orientation information. For example, the orientation information may be input by the target user. The candidate data extracting section 203 may determine orientation of the target user on the basis of the target user's behavior in the data distribution service in the past, and may generate orientation information on the basis of a result of the determination. For example, for (i) a target user who has made selection for a future prospect, trend watching, or the like in the data distribution service or (ii) a target user whose obtained data includes, at a high percentage, data not having FB information from other company(ies), orientation information indicating that the target user is future-oriented may be generated. For another example, for (i) a target user who has made selection for guarantee, safety, or security or (ii) a target user whose obtained data includes, at a high percentage, data having FB information from other company(ies), orientation information indicating that the target user is conservative-oriented may be generated. Note that it is not essential to input or generate the orientation information in S32. Alternatively, for example, the orientation information having been input or generated may be stored in the storage section 21 in advance. In this case, in S32, the orientation information stored in the storage section 21 may be obtained.

In S33, the candidate data extracting section 203 determines, on the basis of the orientation information obtained in S32, related user associated information used to extract candidate data. The related user associated information corresponding to the orientation information may be set in advance. For example, in a case where the orientation information indicating that a future-oriented nature is obtained, the interest information may be used; in a case where the orientation information indicating that a conservative-oriented nature is obtained, the FB information may be used; in a case where the orientation information indicating that a balanced-future-oriented nature is obtained, both the interest information and the FB information may be used.

In S34, the candidate data extracting section 203 extracts pieces of candidate data on the basis of the related user associated information determined in S33. For example, in a case where the candidate data extracting section 203 determines, in S33, to extract the pieces of candidate data with use of the related information, the candidate data extracting section 203 extracts, as the pieces of candidate data, pieces of interest target data indicated by the related information. Similarly, in a case where the candidate data extracting section 203 determines, in S33, to extract the pieces of candidate data with use of the FB information, the candidate data extracting section 203 extracts, as the pieces of candidate data, pieces of obtained data indicated by the FB information. Further, in a case where the candidate data extracting section 203 determines, in S33, to extract the pieces of candidate data with use of both the interest information and the FB information, the candidate data extracting section 203 extracts, as the pieces of candidate data, both the pieces of interest target data and the pieces of obtained data.

In S35, the candidate data evaluating section 204 calculates evaluation values of the pieces of candidate data extracted in S34. Specifically, in a case where the pieces of obtained data are extracted as the pieces of obtained data in S34, the candidate data evaluating section 204 calculates evaluation values of the pieces of obtained data. Further, in a case where the pieces of interest target data are extracted as the pieces of candidate data in S34, the candidate data evaluating section 204 calculates evaluation values of the pieces of interest target data. Then, in a case where the pieces of obtained data and the pieces of interest target data are extracted as the pieces of candidate data in S34, the candidate data evaluating section 204 calculates evaluation values of the pieces of obtained data and evaluation values of the pieces of interest target data. The evaluation values may be calculated both in a manner with respect to a certain industry category and in a manner without distinction of the industry category, similarly to the example shown in FIG. 6.

As described above, the pieces of candidate data are extracted on the basis of the related user associated information corresponding to the orientation information obtained in S32, and consequently recommendation information corresponding to the orientation information is generated in S37. For example, for a target user who is future-oriented, recommendation information recommending interest target data is generated. Meanwhile, for a target user who is conservative-oriented, recommendation information recommending obtained data is generated.

It is assumed that, in S34, both the pieces of interest target data and the pieces of obtained data are extracted. Then, in S35, the candidate data evaluating section 204 may weight the evaluation values at the time of calculation of the evaluation values. In this case, for a target user who is future-oriented, the candidate data evaluating section 204 may weight the evaluation values so that a weight of an evaluation value obtained on the basis of the pieces of interest target data is greater than a weight of an evaluation value obtained on the basis of the pieces of obtained data. Meanwhile, for a target user who is conservative-oriented, the candidate data evaluating section 204 may weight the evaluation values so that a weight of an evaluation value obtained on the basis of the pieces of obtained data is greater than a weight of an evaluation value obtained on the basis of the pieces of interest target data. Further, for a target user who is balanced-oriented, the candidate data evaluating section 204 may weight the evaluation values so that a weight of an evaluation value obtained on the basis of the pieces of obtained data is equal to or almost equal to a weight of an evaluation value obtained on the basis of the pieces of interest target data. With this, even in a case where the recommendation information is generated based on both the pieces of interest target data and the pieces of obtained data, it is possible to reflect the orientation information.

Here, it is unknown whether or not the pieces of interest target data indicated by the interest information have been obtained by the related user(s), and thus it is somewhat unclear whether or not the pieces of interest target data are useful for the related user(s). Therefore, it is also somewhat unclear whether or not the pieces of interest target data are useful for the target user. However, if recommendation information indicating interest target data having not been obtained by the related user is generated and is presented to the target user, the target user may possibly find usefulness of that data at a timing earlier than the related user. That is, it can be said that the recommendation information indicating the interest target data is information suitable for a target user who is innovation-oriented.

Meanwhile, the FB information indicates a content of a feedback given to the obtained data. Thus, by referring to the content of the feedback, it is possible to easily determine whether or not the obtained data is useful for the target user. Therefore, in a case where the recommendation information indicating the obtained data is to be generated, it is possible to recommend, to the target user, data which is highly likely to be useful for the target user. That is, it can be said that the recommendation information indicating the obtained data to which the feedback has been given is information suitable for a target user who is conservative-oriented.

Therefore, as described above, the information processing apparatus 2 in accordance with the present example embodiment may be configured such that, in a case where related user associated information includes interest information and FB information, the recommendation information generating section 205 generates recommendation information on the basis of one or both of the interest information and the FB information corresponding to orientation information indicating the target user's orientation. With this, it is possible to attain, in addition to the effect given by the information processing apparatus 1 in accordance with the first example embodiment, an effect of enabling generation of recommendation information adapted to the target user's orientation.

[Variations]

The processes described in the foregoing example embodiments may be carried out by any entity, which is not limited to the foregoing examples. That is, an apparatus constituting the recommendation information generation system can be modified as appropriate, as long as the apparatus can execute each process described in the foregoing example embodiments.

For example, the recommendation information generation system 100 shown in FIG. 3 is configured such that the single information processing apparatus 2 carries out all of the provision of the data distribution service (e.g., a control for accepting and transmitting registered data), extraction of the related user, and generation of the recommendation information. Alternatively, these processes may be carried out by individual apparatuses. For example, the recommendation information generation system may include: a service providing apparatus that provides a data distribution service; a related user extracting apparatus that extracts, for a target user of the data distribution service, a related user on the basis of target user associated information associated with the target user; and a recommendation information generating apparatus that generates, on the basis of related user associated information associated with the related user, recommendation information indicating data obtaining of which is recommended to the target user.

### Software Implementation Example

Part of or the whole of functions of the information processing apparatuses 1 and 2 can be realized by hardware such as an integrated circuit (IC chip) or can be alternatively realized by software.

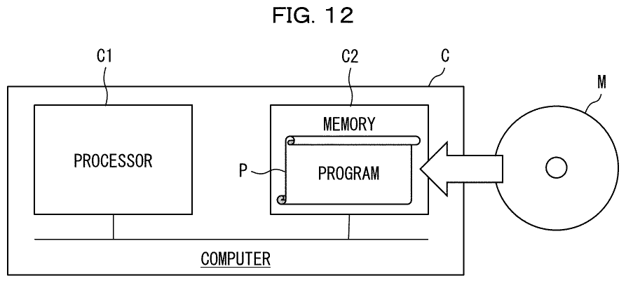

In the latter case, each of the information processing apparatuses 1 and 2 is realized by, for example, a computer that executes instructions of a program that is software realizing the foregoing functions. FIG. 12 shows an example of such a computer (hereinafter, referred to as a “computer C”). The computer C includes at least one processor C1 and at least one memory C2. The memory C2 has a program P stored therein, the program P causing the computer C to operate as the information processing apparatus 1 or 2. In the computer C, the processor C1 reads and executes the program P from the memory C2, thereby realizing the functions of the information processing apparatus 1 or 2.

The processor C1 may be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination of any of them. The memory C2 may be, for example, a flash memory, hard disk drive (HDD), solid state drive (SSD), or a combination of any of them.

The computer C may further include a random access memory (RAM) in which the program P is loaded when executed and various data is temporarily stored. In addition, the computer C may further include a communication interface via which the computer C transmits/receives data to/from another device. The computer C may further include an input-output interface via which the computer C is connected to an input-output device such as a keyboard, a mouse, a display, and/or a printer.

The program P can be stored in a non-transitory, tangible storage medium M capable of being read by the computer C. Examples of the storage medium M encompass a tape, a disk, a card, a semiconductor memory, and a programmable logic circuit. The computer C can obtain the program P via the storage medium M. Alternatively, the program P can be transmitted via a transmission medium. Examples of such a transmission medium encompass a communication network and a broadcast wave. The computer C can also obtain the program P via the transmission medium.

[Supplementary Remarks 1]

The present invention is not limited to the example embodiments, but can be altered by a skilled person in the art within the scope of the claims. The present invention also encompasses, in its technical scope, any embodiment derived by combining technical means disclosed in differing embodiments.

[Supplementary Remarks 2]

Some or all of the above example embodiments can be described as below. Note, however, that the present invention is not limited to example aspects described below.

(Supplementary Note 1)

An information processing apparatus including: a related user extracting means that extracts, for a target user among a plurality of users of a data distribution service, at least one related user relating to the target user from among the plurality of users on a basis of target user associated information which is associated with the target user, the data distribution service allowing data registered by a certain one of the plurality of users to be obtained by another one of the plurality of users; and a recommendation information generating means that generates, on a basis of related user associated information which is associated with the at least one related user, recommendation information indicating data which is included in data obtainable through the data distribution service and obtaining of which is recommended to the target user. With this configuration, it is possible to enhance convenience of the data distribution service.

(Supplementary Note 2)

The information processing apparatus described in Supplementary Note 1, wherein: the target user associated information includes information indicating a category of data that the target user has registered in the data distribution service; and the related user extracting means extracts, as the at least one related user, a user who has registered, in the data distribution service, data of a category identical to or corresponding to the category of the data that the target user has registered in the data distribution service. With this configuration, it is possible to increase the possibility of generating recommendation information indicating registered data useful for the target user.

(Supplementary Note 3)

The information processing apparatus described in Supplementary Note 1, wherein: the target user associated information includes information indicating an industry category of the target user; and the related user extracting means extracts, as the at least one related user, a user of an industry category identical to or corresponding to the industry category of the target user. With this configuration, it is possible to increase the possibility of generating recommendation information indicating registered data useful for the target user.

(Supplementary Note 4)

The information processing apparatus described in any one of Supplementary Notes 1 to 3, wherein: the related user associated information includes interest information indicating interest target data, which is data in which the at least one related user has interest; and the recommendation information generating means generates the recommendation information recommending obtaining of the interest target data. With this configuration, it is possible to increase the possibility of generating recommendation information indicating registered data useful for the target user.

(Supplementary Note 5)

The information processing apparatus described in any one of Supplementary Notes 1 to 3, wherein: the related user associated information includes information indicating obtained data, which has been obtained by the at least one related user through the data distribution service; and the recommendation information generating means generates the recommendation information recommending obtaining of the obtained data. With this configuration, it is possible to increase the possibility of generating recommendation information indicating registered data useful for the target user.

(Supplementary Note 6)

The information processing apparatus described in Supplementary Note 5, wherein: the related user associated information includes feedback information indicating a content of a feedback having been given, by the at least one related user, to the obtained data that the at least one related user has obtained through the data distribution service; and the recommendation information generating means generates the recommendation information recommending obtaining of the obtained data to which a feedback having a certain content has been given. With this configuration, it is possible to further increase the possibility of generating recommendation information indicating registered data useful for the target user.

(Supplementary Note 7)

The information processing apparatus described in any one of Supplementary Notes 1 to 6, wherein: the recommendation information generating means generates the recommendation information on a basis of the related user associated information of, among the at least one related user extracted by the related user extracting means, a related user of a certain industry category. With this configuration, it is possible to generate recommendation information characteristic to the certain industry category.

(Supplementary Note 8)

The information processing apparatus described in Supplementary Note 1, wherein: the related user associated information includes (i) interest information indicating interest target data, which is data in which the at least one related user has interest, and (ii) feedback information indicating a content of a feedback given, by the at least one related user, to the obtained data that the at least one related user has obtained through the data distribution service; and the recommendation information generating means generates the recommendation information on a basis of one or both of the interest information and the feedback information corresponding to orientation information indicating the target user's orientation. With this, it is possible to generate recommendation information adapted to the target user's orientation.

(Supplementary Note 9)

A recommendation information generation method including: at least one processor extracting, for a target user among a plurality of users of a data distribution service, at least one related user relating to the target user from among the plurality of users on a basis of target user associated information which is associated with the target user, the data distribution service allowing data registered by a certain one of the plurality of users to be obtained by another one of the plurality of users; and at least one processor generating, on a basis of related user associated information which is associated with the at least one related user, recommendation information indicating data which is included in data obtainable through the data distribution service and obtaining of which is recommended to the target user. With this recommendation information generation method, it is possible to enhance convenience of the data distribution service.

(Supplementary Note 10)

A recommendation information generation program causing a computer to function as the information processing apparatus described in Supplementary Note 1, the program causing the computer to function as each of the foregoing means. With this program, it is possible to enhance convenience of the data distribution service.

(Supplementary Note 11)

A recommendation information generation system including: a service providing apparatus that provides a data distribution service allowing data registered by a certain user to be obtained by another user; a related user extracting apparatus that extracts, for a target user among a plurality of users of the data distribution service, at least one related user relating to the target user from among the plurality of users, on a basis of target user associated information which is associated with the target user; and a recommendation information generating apparatus that generates, on a basis of related user associated information which is associated with the at least one related user, recommendation information indicating data which is included in data obtainable through the data distribution service and obtaining of which is recommended to the target user. With this recommendation information generation system, it is possible to enhance convenience of the recommendation information generation system.

[Supplementary Remarks 3]

Some or all of the above example embodiments can alternatively be described as below. An information processing apparatus including at least one processor, the at least one processor executing a process of extracting, for a target user among a plurality of users of a data distribution service, at least one related user relating to the target user from among the plurality of users on a basis of target user associated information which is associated with the target user, the data distribution service allowing data registered by a certain one of the plurality of users to be obtained by another one of the plurality of users; and a process of generating, on a basis of related user associated information which is associated with the at least one related user, recommendation information indicating data which is included in data obtainable through the data distribution service and obtaining of which is recommended to the target user.

Note that the information processing apparatus may further include a memory. The memory may have a program stored therein, the program causing the processor to execute: the process of extracting the related user; and the process of generating the recommendation information. Further, this program may be stored in a computer-readable, non-transitory, tangible storage medium.

### REFERENCE SIGNS LIST

1: information processing apparatus
11: related user extracting section
12: recommendation information generating section
100: recommendation information generation system
2: information processing apparatus
202: related user extracting section
205: recommendation information generating section
212: recommendation information

What is claimed is:

1. An information processing apparatus comprising at least one processor,
the at least one processor executing:
a related user extracting process of extracting, for a target user among a plurality of users of a data distribution service, at least one related user relating to the target user from among the plurality of users on a basis of target user associated information which is associated with the target user, the data distribution service allowing data registered by a certain one of the plurality of users to be obtained by another one of the plurality of users; and
a recommendation information generating process of generating, on a basis of related user associated information which is associated with the at least one related user, recommendation information indicating data which is included in data obtainable through the data distribution service and obtaining of which is recommended to the target user.

2. The information processing apparatus according to claim 1, wherein:
the target user associated information includes information indicating a category of data that the target user has registered in the data distribution service; and
in the related user extracting process, the at least one processor extracts, as the at least one related user, a user who has registered, in the data distribution service, data of a category identical to or corresponding to the category of the data that the target user has registered in the data distribution service.

3. The information processing apparatus according to claim 1, wherein:
the target user associated information includes information indicating an industry category of the target user; and
in the related user extracting process, the at least one processor extracts, as the at least one related user, a user of an industry category identical to or corresponding to the industry category of the target user.

4. The information processing apparatus according to claim 1, wherein:
the related user associated information includes interest information indicating interest target data, which is data in which the at least one related user has interest; and
in the recommendation information generating process, the at least one processor generates the recommendation information recommending obtaining of the interest target data.

5. The information processing apparatus according to claim 1, wherein:
the related user associated information includes information indicating obtained data, which has been obtained by the at least one related user through the data distribution service; and
in the recommendation information generating process, the at least one processor generates the recommendation information recommending obtaining of the obtained data.

6. The information processing apparatus according to claim 5, wherein:
the related user associated information includes feedback information indicating a content of a feedback having been given, by the at least one related user, to the obtained data that the at least one related user has obtained through the data distribution service; and
in the recommendation information generating process, the at least one processor generates the recommendation information recommending obtaining of the obtained data to which a feedback having a certain content has been given.

7. The information processing apparatus according to claim 1, wherein:
in the recommendation information generating process, the at least one processor generates the recommendation information on a basis of the related user associated information of, among the at least one related user extracted in the related user extracting process, a related user of a certain industry category.

8. The information processing apparatus according to claim 1, wherein:
the related user associated information includes (i) interest information indicating interest target data, which is data in which the at least one related user has interest, and (ii) feedback information indicating a content of a feedback given, by the at least one related user, to the obtained data that the at least one related user has obtained through the data distribution service; and
in the recommendation information generating process, the at least one processor generates the recommendation information on a basis of one or both of the interest information and the feedback information corresponding to orientation information indicating the target user's orientation.

9. A recommendation information generation method comprising:
at least one processor extracting, for a target user among a plurality of users of a data distribution service, at least one related user relating to the target user from among the plurality of users on a basis of target user associated information which is associated with the target user, the data distribution service allowing data registered by a certain one of the plurality of users to be obtained by another one of the plurality of users; and
at least one processor generating, on a basis of related user associated information which is associated with the at least one related user, recommendation information indicating data which is included in data obtainable through the data distribution service and obtaining of which is recommended to the target user.

10. A non-transitory computer-readable storage medium in which a program is stored, the program causing a computer to execute:
a related user extracting process of extracting, for a target user among a plurality of users of a data distribution service, at least one related user relating to the target user from among the plurality of users on a basis of target user associated information which is associated with the target user, the data distribution service allowing data registered by a certain one of the plurality of users to be obtained by another one of the plurality of users; and
a recommendation information generating process of generating, on a basis of related user associated information which is associated with the at least one related user, recommendation information indicating data which is included in data obtainable through the data distribution service and obtaining of which is recommended to the target user.
